(19) United States
(12) Patent Application Publication
(10) Pub. No.: US 2010/0021839 A1
(43) Pub. Date: Jan. 28, 2010

(54) TONER COMPOSITIONS

(75) Inventors: Valerie M. Farrugia, Oakville (CA); Barkev Keoshkerian, Thornhill (CA); Kristin M. Pouw, Hamilton (CA)

Correspondence Address: Xerox Corporation (CDFS), 445 Broad Hollow Rd.-Suite 420, Melville, NY, 11747, US

(73) Assignee: XEROX CORPORATION, Norwalk, CT (US)

(21) Appl. No.: 12/177,209

(22) Filed: Jul. 22, 2008

(51) Int. Cl. G03G 9/08

(52) U.S. Cl. 430/108.4; 430/137.14; 430/110.3; 430/108.8; 430/108.1

(57) ABSTRACT

Methods for modifying the acid value of an unsaturated polyester resin suitable for use in forming toner particles are provided. In embodiments, methods may include contacting at least one unsaturated polyester resin with at least one grafting monomer, polymerizing the graft monomer and unsaturated polyester resin to form a graft copolymer, and then utilizing the graft copolymer to form toner particles by combining the graft copolymer with an optional colorant, at least one surfactant, and an optional wax. Toners produced by these methods are also provided.

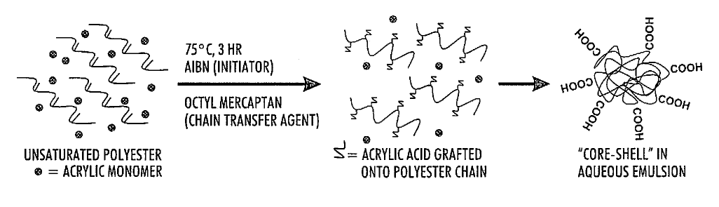

### BACKGROUND

The present disclosure relates to toners suitable for electrophotographic apparatuses.

Numerous processes are within the purview of those skilled in the art for the preparation of toners. Emulsion aggregation (EA) is one such method. These toners may be formed by aggregating a colorant with a latex polymer formed by emulsion polymerization. For example, U.S. Pat. No. 5,853,943, the disclosure of which is hereby incorporated by reference in its entirety, is directed to a semi-continuous emulsion polymerization process for preparing a latex by first forming a seed polymer. Other examples of emulsion/aggregation/coalescing processes for the preparation of toners are illustrated in U.S. Pat. Nos. 5,403,693, 5,418,108, 5,364,729, and 5,346,797, the disclosures of each of which are hereby incorporated by reference in their entirety. Other processes are disclosed in U.S. Pat. Nos. 5,527,658, 5,585,215, 5,650,255, 5,650,256 and 5,501,935, the disclosures of each of which are hereby incorporated by reference in their entirety.

Polyester EA ultra low melt (ULM) toners have been prepared utilizing amorphous and crystalline polyester resins. For these resins, ionic groups which may be used to both disperse polyesters into emulsions and aggregate polyester emulsions into toner particles include sulfonate and carboxylic acid functional groups. Though sulfonate groups provide charge to the particle, they may be quite hydrophilic and may absorb too much moisture in high humidity environments (A-zone), resulting in blocking and depressed resistivity.

Alternatively, polyesters may be utilized in the formation of toners wherein the resin groups of the polymer chains have been modified by the addition of an acid anhydride. For example, this approach may add trimellitic anhydride (TMA) at the end of the polymerization to react with the hydroxyl end groups in the polyester chain, either amorphous or crystalline, to give two carboxylic acid moieties per chain end. Unfortunately, acid functionality may be limited to the terminal hydroxyl end groups. It has also been found by matrix assisted laser desorption ionization-time of flight (“MALDI-TOF”) that upon reaction with TMA, the crystalline-type polyester may degrade and produce a large amount of fragments with acid-alcohol end groups and a new series of fragments capped with an acid on both ends. The degradation which occurs may arise from harsh conditions during TMA treatment (i.e., high temperature), which creates an environment suitable for acidolysis, or some other degradation mechanism, instead of functionalization.

Resins having improved ability to be dispersed into emulsions for formation of toner particles remain desirable.

### SUMMARY

Processes for producing resins are provided. The resulting resins may be dispersed into emulsions for the formation of toner particles. In embodiments, a process of the present disclosure may include contacting at least one unsaturated polyester resin with at least one grafting monomer such as carboxylic acids, carboxylic anhydrides, styrenes, alpha methyl styrene, alkyl esters of acrylic acid, alkyl esters of methacrylic acid, and combinations thereof polymerizing the graft monomer and unsaturated polyester resin to form a graft copolymer possessing an acid number of from about 10 milliequivalents of potassium hydroxide per gram of resin to about 1000 milliequivalents of potassium hydroxide per gram of resin, contacting the graft copolymer with an optional colorant, at least one surfactant, and an optional wax to form small particles in a dispersion, aggregating the small particles, coalescing the aggregated particles to form toner particles and recovering the toner particles.

In embodiments, a process of the present disclosure may include contacting at least one unsaturated polyester resin such as amorphous polyester resins, crystalline polyester resins, semi-crystalline polyester resins, and combinations thereof, with at least one grafting monomer such as acrylic acid, maleic acid, fumaric acid, citraconic acid, mesaconic acid, maleic anhydride, 4-methyl cyclohex-4-ene-1,2-dicarboxylic acid, 4-methyl cyclohex-4-ene-1,2-dicarboxylic anhydride, bicyclo(2.2.2)oct-5-ene-2,3-dicarboxylic acid, bicyclo(2.2.2)oct-5-ene-2,3-dicarboxylic anhydride, bicyclo(2.2.1)hept-5-ene-2,3-dicarboxylic acid, bicyclo(2.2.1)hept-5-ene-2,3-dicarboxylic anhydride, tetrahydrophthalic acid, tetrahydrophthalic anhydride, methylbicyclo(2.2.1)hept-5-ene-2,3-dicarboxylic acid, methylbicyclo(2.2.1)hept-5-ene-2,3-dicarboxylic anhydride, nadic anhydride, methyl nadic anhydride, himic anhydride, methyl himic anhydride, methacrylic acid, methyl acrylate, methyl methacrylate, ethyl acrylate, ethyl methacrylate, propyl acrylate, propyl methacrylate, butyl acrylate, butyl methacrylate, hydroxyethyl acrylate, hydroxyethyl methacrylate, hydroxypropyl methacrylate, acrylonitrile, methacrylonitrile, acrylamide, methacrylamide, and combinations thereof, and at least one initiator such as peroxides, persulfates, redox couples, azo compounds, ultrasound, ultraviolet light, ionizing radiation and combinations thereof, and polymerizing the graft monomer and unsaturated polyester resin for a period of time of from about 30 minutes to about 5 hours at a temperature of from about 60° C. to about 100° C. to form a graft copolymer possessing an acid number of from about 10 milliequivalents of potassium hydroxide per gram of resin to about 1000 milliequivalents of potassium hydroxide per gram of resin. The graft copolymer may be contacted with an optional colorant, at least one surfactant, and an optional wax to form small particles in a dispersion, which may then be aggregated to form aggregated particles, and coalescing the aggregated particles to form toner particles. The toner particles may then be recovered.

Toner particles including these resins are also provided. In embodiments, a toner may include at least one resin including a graft copolymer including at least one unsaturated polyester resin possessing ethylenically unsaturated polymerizable monomers such as ethyl acrylate, n-butyl acrylate, isobutyl acrylate, t-butyl acrylate, 2-ethylhexyl acrylate, dodecyl acrylate, methyl methacrylate, ethyl methacrylate, n-butyl methacrylate, isobutyl methacrylate, t-butyl methacrylate, 2-ethylhexyl methacrylate, lauryl methacrylate, styrene, α-methylstyrene, vinyltoluene, p-t-butylstyrene, acrylonitrile, methacrylonitrile, glycidyl acrylate, glycidyl methacrylate, 2-hydroxyethyl acrylate, 2-hydroxypropyl acrylate, 1-methyl-2-hydroxyethyl acrylate, 2-hydroxyethyl methacrylate, 2-hydroxypropyl methacrylate, 1-methyl-2-hydroxyethyl methacrylate, polypropylene glycol monomethacrylate, glycerol monomethacrylate, 3-chloro-2-hydroxypropyl methacrylate, acrylic acid, methacrylic acid, crotonic acid, itaconic acid, fumaric acid, maleic acid, acrylamide, methacrylamide, N-methylolacrylamide, N-alkoxymethylacrylamide having an alkyl moiety of 1 to 14 carbon atoms, diacetone acrylamide, hydroxymethyldiacetone acrylamide, N-methylolmethacrylamide, N-alkoxymethylmethacrylamide having an alkyl moiety of 1 to 14 carbon atoms, the addition product between a polyisocyanate compound having at least one free isocyanate group and at least one isocyanate group blocked by a blocking agent and an ethylenically unsaturated compound having at least one hydroxyl group, and combinations thereof, present in an amount of from about 1 mol % to about 20 mol % of the resin, and at least one grafting monomer such as acrylic acid, maleic acid, fumaric acid, citraconic acid, mesaconic acid, maleic anhydride, 4-methyl cyclohex-4-ene-1,2-dicarboxylic acid, 4-methyl cyclohex-4-ene-1,2-dicarboxylic anhydride, bicyclo(2.2.2)oct-5-ene-2,3-dicarboxylic acid, bicyclo(2.2.2)oct-5-ene-2,3-dicarboxylic anhydride, bicyclo(2.2.1)hept-5-ene-2,3-dicarboxylic acid, bicyclo(2.2.1)hept-5-ene-2,3-dicarboxylic anhydride, tetrahydrophthalic acid, tetrahydrophthalic anhydride, methylbicyclo(2.2.1)hept-5-ene-2,3-dicarboxylic acid, methylbicyclo(2.2.1)hept-5-ene-2,3-dicarboxylic anhydride, nadic anhydride, methyl nadic anhydride, himic anhydride, methyl himic anhydride, methacrylic acid, methyl acrylate, methyl methacrylate, ethyl acrylate, ethyl methacrylate, propyl acrylate, propyl methacrylate, butyl acrylate, butyl methacrylate, hydroxyethyl acrylate, hydroxyethyl methacrylate, hydroxypropyl methacrylate, acrylonitrile, methyacrylonitrile, acrylamide, methacrylamide, and combinations thereof. Toner particles may also include an optional colorant, at least one surfactant, and an optional wax, wherein the weight ratio of the at least one unsaturated polyester resin to the at least one grafting monomer is from about 95:5 to about 50:50, and wherein the acid number of the polyester resin is from about 10 milliequivalents of potassium hydroxide per gram of resin to about 1000 milliequivalents of potassium hydroxide per grain of resin, and wherein particles including the toner have a volume average diameter of from about 3 μm to about 15 μm, and a circularity of from about 0.9 to about 1.

### BRIEF DESCRIPTION OF THE DRAWINGS

Various embodiments of the present disclosure will be described herein below with reference to the FIGURE wherein:

The FIGURE is a depiction of the reaction of a grafting monomer with a polyester chain in accordance with the present disclosure, and the resulting graft copolymer.

### DETAILED DESCRIPTION

The present disclosure provides processes for increasing the acid number of unsaturated polyester resins for EA toner applications. In embodiments, grafting monomers possessing acid groups may be grafted onto unsaturated polyester chains via double bonds along the polymer chain. Unlike traditional methods of acid number modification, which include treatment with trimellitic acid (TMA) via hydroxyl end groups, the process of the present disclosure may be an effective way of acidification because it may be effected along the polymer chain. Moreover, by utilizing starting polyesters with sufficient unsaturation, the modified resins of the present disclosure can become self dispersible in water.

### Resins

Any latex resin may be utilized in forming a toner of the present disclosure, so long as it has sufficient unsaturation to permit the grafting reaction described herein and the resulting formation of a graft copolymer. Such resins, in turn, may be made of any suitable monomer. Suitable monomers useful in forming the resin include, but are not limited to, styrenes, acrylates, methacrylates, butadienes, isoprenes, acrylic acids, methacrylic acids, acrylonitriles, diol, diacid, diamine, diester, mixtures thereof, and the like. Any monomer employed may be selected depending upon the particular polymer to be utilized. In embodiments, any resin having unsaturation in the backbone of the polymer may be utilized.

In embodiments, the polymer utilized to form the resin may be a polyester resin, including the resins described in U.S. Pat. Nos. 6,593,049 and 6,756,176, the disclosures of each of which are hereby incorporated by reference in their entirety. Suitable resins may also include a mixture of an amorphous polyester resin and a crystalline polyester resin as described in U.S. Pat. No. 6,830,860, the disclosure of which is hereby incorporated by reference in its entirety.

In embodiments, the resin may be a polyester resin formed by reacting a diol with a diacid in the presence of an optional catalyst. For forming a crystalline polyester, suitable organic diols include aliphatic diols with from about 2 to about 36 carbon atoms, such as 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, ethylene glycol, combinations thereof, and the like. The aliphatic diol may be, for example, selected in an amount of from about 40 to about 60 mole percent, in embodiments from about 42 to about 55 mole percent, in embodiments from about 45 to about 53 mole percent, and the alkali sulfo-aliphatic diol can be selected in an amount of from about 0 to about 10 mole percent, in embodiments from about 1 to about 4 mole percent of the resin.

Examples of organic diacids or diesters selected for the preparation of the crystalline resins include oxalic acid, succinic acid, glutaric acid, adipic acid, suberic acid, azelaic acid, fumaric acid, maleic acid, dodecanedioic acid, sebacic acid, phthalic acid, isophthalic acid, terephthalic acid, naphthalene-2,6-dicarboxylic acid, naphthalene-2,7-dicarboxylic acid, cyclohexane dicarboxylic acid, malonic acid and mesaconic acid, a diester or anhydride thereof, and combinations thereof. The organic diacid may be selected in an amount of, for example, in embodiments from about 40 to about 60 mole percent, in embodiments from about 42 to about 55 mole percent, in embodiments from about 45 to about 53 mole percent.

Examples of crystalline resins include polyesters, polyamides, polyimides and polyolefins. In embodiments, the resin may be unsaturated, e.g., may include polyalkenes. Polyalkenes which may be utilized may contain unsaturation somewhere along the polymer backbone and may include, for example, polyethylene, polybutylene, polyisobutyrate, ethylene-propylene copolymers, ethylene-vinyl acetate copolymers, polypropylene, mixtures thereof, and the like. Specific crystalline resins may be polyester based, such as poly(ethylene-adipate), poly(propylene-adipate), poly(butylene-adipate), poly(pentylene-adipate), poly(hexylene-adipate), poly(octylene-adipate), poly(ethylene-succinate), poly(propylene-succinate), poly(butylene-succinate), poly(pentylene-succinate), poly(hexylene-succinate), poly(octylene-succinate), poly(ethylene-sebacate), poly(propylene-sebacate), poly(butylene-sebacate), poly(pentylene-sebacate), poly(hexylene-sebacate), poly(octylene-sebacate), alkali copoly(5-sulfoisophthaloyl)-copoly(ethylene-adipate), poly(decylene-sebacate), poly(decylene-decanoate), poly-(ethylene-decanoate), poly-(ethylene-dodecanoate), poly(nonylene-sebacate), poly(nonylene-decanoate), copoly(ethylene-fumarate)-copoly)-(ethylene-sebacate), copoly(ethylene-fumarate)-copoly)-(ethylene-decanoate), and copoly(ethylene-fumarate)-copoly)-(ethylene-dodecanoate). The crystalline resin may be present, for example, in an amount of from about 5 to about 50 percent by weight of the toner components, in embodiments from about 10 to about 35 percent by weight of the toner components. The crystalline resin can possess various melting points of, for example, from about 30° C. to about 120° C., in embodiments from about 50° C. to about 90° C. The crystalline resin may have a number average molecular weight (Mₙ), as measured by gel permeation chromatography (GPC) of, for example, from about 1,000 to about 50,000, in embodiments from about 2,000 to about 25,000, and a weight average molecular weight (M_{w}) of, for example, from about 2,000 to about 100,000, in embodiments from about 3,000 to about 80,000, as determined by Gel Permeation Chromatography using polystyrene standards. The molecular weight distribution (M_{w}/Mₙ) of the crystalline resin may be, for example, from about 2 to about 6, in embodiments from about 3 to about 4.

Examples of diacid or diesters selected for the preparation of amorphous polyesters include dicarboxylic acids or diesters such as terephthalic acid, phthalic acid, isophthalic acid, fumaric acid, maleic acid, succinic acid, itaconic acid, succinic acid, succinic anhydride, dodecylsuccinic acid, dodecylsuccinic anhydride, glutaric acid, glutaric anhydride, adipic acid, pimelic acid, suberic acid, azelaic acid, dodecane diacid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethyladipate, dimethyl dodecylsuccinate, and combinations thereof. The organic diacid or diester may be present, for example, in an amount from about 40 to about 60 mole percent of the resin, in embodiments from about 42 to about 55 mole percent of the resin, in embodiments from about 45 to about 53 mole percent of the resin.

Examples of diols utilized in generating the amorphous polyester include 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, bis(hydroxyethyl)-bisphenol A, bis(2-hydroxypropyl)-bisphenol A, 1,4-cyclohexanedimethanol, 1,3-cyclohexanedimethanol, xylenedimethanol, cyclohexanediol, diethylene glycol, bis(2-hydroxyethyl) oxide, dipropylene glycol, dibutylene, and combinations thereof. The amount of organic diol selected can vary, and may be present, for example, in an amount from about 40 to about 60 mole percent of the resin, in embodiments from about 42 to about 55 mole percent of the resin, in embodiments from about 45 to about 53 mole percent of the resin.

Polycondensation catalysts which may be utilized for either the crystalline or amorphous polyesters include tetraalkyl titanates, dialkyltin oxides such as dibutyltin oxide, tetraalkyltins such as dibutyltin dilaurate, and dialkyltin oxide hydroxides such as butyltin oxide hydroxide, aluminum alkoxides, alkyl zinc, dialkyl zinc, zinc oxide, stannous oxide, or combinations thereof. Such catalysts may be utilized in amounts of, for example, from about 0.01 mole percent to about 5 mole percent based on the starting diacid or diester used to generate the polyester resin.

In embodiments, suitable amorphous resins include polyesters, polyamides, polyimides, polyolefins, polyethylene, polybutylene, polyisobutyrate, ethylene-propylene copolymers, ethylene-vinyl acetate copolymers, polypropylene, combinations thereof, and the like. Examples of amorphous resins which may be utilized include poly(styrene-acrylate) resins, crosslinked, for example, from about 10 percent to about 70 percent, poly(styrene-acrylate) resins, poly(styrene-methacrylate) resins, crosslinked poly(styrene-methacrylate) resins, poly(styrene-butadiene) resins, crosslinked poly(styrene-butadiene) resins, alkali sulfonated-polyester resins, branched alkali sulfonated-polyester resins, alkali sulfonated-polyimide resins, branched alkali sulfonated-polyimide resins, alkali sulfonated poly(styrene-acrylate) resins, crosslinked alkali sulfonated poly(styrene-acrylate) resins, poly(styrene-methacrylate) resins, crosslinked alkali sulfonated-poly(styrene-methacrylate) resins, alkali sulfonated-poly(styrene-butadiene) resins, and crosslinked alkali sulfonated poly(styrene-butadiene) resins. Alkali sulfonated polyester resins may be useful in embodiments, such as the metal or alkali salts of copoly(ethylene-terephthalate)-copoly(ethylene-5-sulfo-isophthalate), copoly(propylene-terephthalate)-copoly(propylene-5-sulfo-isophthalate), copoly(diethylene-terephthalate)-copoly(diethylene-5-sulfo-isophthalate), copoly(propylene-diethylene-terephthalate)-copoly(propylene-diethylene-5-sulfoisophthalate), copoly(propylene-butylene-terephthalate)-copoly(propylene-butylene-5-sulfo-isophthalate), and copoly(propoxylated bisphenol-A-fumarate)-copoly(propoxylated bisphenol A-5-sulfo-isophthalate).

Examples of other suitable latex resins or polymers which may be utilized include, but are not limited to, poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylonitrile), and poly(styrene-butyl acrylate-acrylonitrile-acrylic acid), and combinations thereof. The polymers may be block, random, or alternating copolymers.

In embodiments, an unsaturated polyester resin may be utilized as a latex resin. Examples of such resins include those disclosed in U.S. Pat. No. 6,063,827, the disclosure of which is hereby incorporated by reference in its entirety. Exemplary unsaturated polyester resins include, but are not limited to, poly(propoxylated bisphenol co-fumarate), poly(ethoxylated bisphenol co-fumarate), poly(butyloxylated bisphenol co-fumarate), poly(co-propoxylated bisphenol co-ethoxylated bisphenol co-fumarate), poly(1,2-propylene fumarate), poly(propoxylated bisphenol co-maleate), poly(ethoxylated bisphenol co-maleate), poly(butyloxylated bisphenol co-maleate), poly(co-propoxylated bisphenol co-ethoxylated bisphenol co-maleate), poly(,2-propylene maleate), poly(propoxylated bisphenol co-itaconate), poly(ethoxylated bisphenol co-itaconate), poly(butyloxylated bisphenol co-itaconate), poly(co-propoxylated bisphenol co-ethoxylated bisphenol co-itaconate), poly(1,2-propylene itaconate), and combinations thereof.

In embodiments, a suitable amorphous polyester resin may be a poly(propoxylated bisphenol A co-fumarate) resin having the following formula (I):

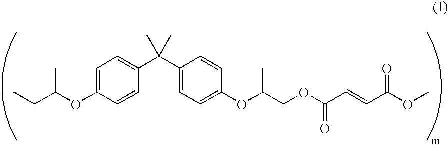

wherein m may be from about 5 to about 1000.

An example of a linear propoxylated bisphenol A fumarate resin which may be utilized as a latex resin is available under the trade name SPARII from Resana S/A Industrias Quimicas, Sao Paulo Brazil. Other propoxylated bisphenol A fumarate resins that may be utilized and are commercially available include GTUF and FPESL-2 from Kao Corporation, Japan, and EM 181635 from Reichhold, Research Triangle Park, N.C. and the like.

Suitable crystalline resins include those disclosed in U.S. Patent Application Publication No. 2006/0222991, the disclosure of which is hereby incorporated by reference in its entirety. In embodiments, a suitable crystalline resin may be composed of ethylene glycol and a mixture of dodecanedioic acid and fumaric acid co-monomers with the following formula:

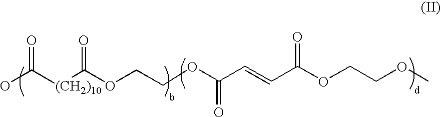

wherein b is from 5 to 2000 and d is from 5 to 2000.

One, two, or more toner resins may be used. In embodiments where two or more toner resins are used, the toner resins may be in any suitable ratio (e.g., weight ratio) such as for instance about 10% first resin/90% second resin to about 90% first resin/10% second resin. In embodiments, the amorphous resin utilized may be linear.

In embodiments, the resin may be formed by emulsion polymerization methods. In other embodiments, a pre-made resin may be utilized to form the toner.

The resin described above may be utilized to form toner compositions. Such toner compositions may include optional colorants, waxes, and other additives. Toners may be formed utilizing any method within the purview of those skilled in the art.

The resins utilized to form the toner may have a number average molecular weight (Mₙ) of less than about 500,000, for example, from about 1,000 to about 450,000, in embodiments from about 2,000 to about 250,000, and a weight average molecular weight (M_{w}) of less than about 600,000, for example, from about 2,000 to about 550,000, in embodiments from about 3,000 to about 300,000, as determined by Gel Permeation Chromatography (GPC) using polystyrene standards. For example, in embodiments, a poly(propoxylated bisphenol A co-fumarate) resin as described above may be utilized in forming the toner. Such a polyester resin may have an Mn from about 5,000 to about 500,000, in embodiments from about 10,000 to about 250,000, and a Mw of from about 7,000 to about 600,000, in embodiments from about 20,000 to about 300,000. In other embodiments, a crystalline resin may include a resin composed of ethylene glycol and a mixture of dodecanedioic acid and fumaric acid co-monomers and may be utilized in forming the toner. Such a polyester resin may have an Mn of from about 1,000 to about 50,000, in embodiments from about 2,000 to about 25,000, and a Mw of from about 2,000 to about 100,000, in embodiments from about 3,000 to about 80,000.

In embodiments, the resin utilized in the toner may have a glass transition temperature of from about 40° C. to about 80° C., in embodiments from about 50° C. to about 70° C.

In embodiments, as noted above, an unsaturated polyester resin may be utilized to form a toner. Such a resin may possess ethylenically unsaturated polymerizable units, for example: esters of acrylic acid and methacrylic acid with alkanols having from about 1 to about 15 carbon atoms, including ethyl acrylate, n-butyl acrylate, isobutyl acrylate, t-butyl acrylate, 2-ethylhexyl acrylate, dodecyl acrylate, methyl methacrylate, ethyl methacrylate, n-butyl methacrylate, isobutyl methacrylate, t-butyl methacrylate, 2-ethylhexyl methacrylate, lauryl methacrylate, and combinations thereof; styrene and its derivatives, including styrene, α-ethylstyrene, vinyltoluene, p-t-butylstyrene, and combinations thereof, acrylonitrile and methacrylonitrile; ethylenically unsaturated glycidyl carboxylates, including glycidyl acrylate, glycidyl methacrylate; ethylenically unsaturated monomers having at least one hydroxyl group, including 2-hydroxyethyl acrylate, 2-hydroxypropyl acrylate, 1-methyl-2-hydroxyethyl acrylate, 2-hydroxyethyl methacrylate, 2-hydroxypropyl methacrylate, 1-methyl-2-hydroxyethyl methacrylate, polypropylene glycol monomethacrylate, glycerol monomethacrylate, 3-chloro-2-hydroxypropyl methacrylate; ethylenically unsaturated carboxylic acids, including acrylic acid, methacrylic acid, crotonic acid, itaconic acid, fumaric acid, maleic acid; ethylenically unsaturated compounds having at least one blocked isocyanate group such as the addition product between a polyisocyanate compound, including hexamethylene diisocyanate, tolylene diisocyanate, isophorone diisocyanate, polyisocyanate adducts, and the like having at least one free isocyanate group and at least one isocyanate group blocked by a conventional blocking agent, such as phenols, lactams, active methylene compounds, alcohols, amines, oximes, combined with an ethylenically unsaturated compound having at least one hydroxyl group, including 2-hydroxyethyl methacrylate, 2-hydroxyethyl acrylate, 2-hydroxypropyl methacrylate, acrylic acid, methacrylic acid, itaconic acid, N-methylolacrylamide, as well as the addition product between an ethylenically unsaturated compound having at least one free isocyanate group and a blocking agent; acrylamide and methacrylamide and their derivatives, including N-methylolacrylamide, N-alkoxymethylacrylamide having an alkyl moiety of 1 to 14 carbon atoms, diacetone acrylamide, hydroxymethyldiacetone acrylamide, N-methylolmethacrylamide, N-alkoxymethylmethacrylamide having an alkyl moiety of from about 1 to about 14 carbon atoms, and/or combinations thereof. The desired level of unsaturation may be achieved, in embodiments, by adding an acidic monomer containing a 1,2-ethylenically unsaturated bond such as fumaric acid after the transesterification stage of the polyester synthesis process, so that the level of unsaturation may be of from about 1 mol % to about 20 mol % of the resin, in embodiments from about 4 mol % to about 10 mol % of the resin.

### Grafting

In accordance with the present disclosure, a process for the modification of a polyester resin is provided via double bonds within the polyester backbone. The process of the present disclosure may introduce acid groups along the backbone chain, thereby increasing the acid number of the polyester resin. This increase in the number of acid groups may enhance the dispersibility of the resin in an emulsion and the aggregation of the emulsion into toner particles.

In embodiments, grafting monomers which may be utilized to modify the unsaturated polyester resin may include functional groups such as carboxylic acids. Examples of such monomers include, but are not limited to, carboxylic acids or anhydrides, styrenic acids, alpha methyl styrenic acids, alkyl esters of acrylic acid, alkyl esters of methacrylic acid, combinations thereof, and the like. Exemplary carboxylic acids or anhydrides which may be useful as grafting monomers include compounds such as acrylic acid, maleic acid, fumaric acid, citraconic acid, mesaconic acid, maleic anhydride, 4-methyl cyclohex-4-ene-1,2-dicarboxylic acid or anhydride, bicyclo(2.2.2)oct-5-ene-2,3-dicarboxylic acid or anhydride, bicyclo(2.2.1)hept-5-ene-2,3-dicarboxylic acid or anhydride, tetrahydrophthalic acid or anhydride, methylbicyclo(2.2.1)hept-5-ene-2,3-dicarboxylic acid or anhydride, nadic anhydride, methyl nadic anhydride, himic anhydride, and methyl himic anhydride methacrylic acid, methyl acrylate, methyl methacrylate, ethyl acrylate, ethyl methacrylate, propyl acrylate, propyl methacrylate, butyl acrylate, butyl methacrylate, hydroxyethyl acrylate, hydroxyethyl methacrylate, hydroxypropyl methacrylate, acrylonitrile, methyacrylonitrile, acrylamide, methacrylamide, and monomers copolymerizable therewith, such as styrene, p-methylstyrene and lower monoolefins, combinations thereof, and the like. In embodiments, functionalizing the unsaturated groups within the polyester backbone does not promote acidolysis within the polyester backbone and ensures adequate distribution of carboxylic acid functionality throughout the polyester chain.

The grafting monomers may be combined with the polyester resins so that the weight ratio (sometimes referred to herein as mass ratio) of polyester to grafting monomer is from about 95:5 to about 50:50, in embodiments from about 90:10 to about 60:40.

The graft copolymers of the present disclosure may be made by the polymerization of the unsaturated monomers in the polyester chain and the grafting monomers. Although a variety of competing reactions may be ongoing at any given time and in any given sequence, the graft copolymers produced in accordance with the present disclosure may be obtained by subjecting an emulsion containing the grafting monomers and the polyester, either an amorphous polyester, a crystalline polyester, a semi-crystalline polyester, or any combination thereof, to conditions such that polymerization between the grafting monomers and the polyester chain may occur.

In embodiments, the grafting of a monomer possessing acid groups along the polyester backbone at a point of unsaturation may take place in the presence of an initiator. Examples of suitable initiators include, but are not limited to, free radical initiators including peroxides, persulfates, redox couples, azo compounds, combinations thereof, and the like. In embodiments, initiators which may be used in preparing vinyl or acrylic compositions include a persulfate initiator, such as sodium persulfate. Other initiators suitable for use include ammonium persulfate, potassium persulfate, peroxides, azo compounds, and known redox initiators such as tert-butyl hydroxy peroxide/sodium formaldehyde sulfoxylate, combinations thereof, and the like.

Organic peroxides, and especially those that generate alkoxy radicals, may be utilized in some embodiments. Exemplary peroxides include acyl peroxides, such as benzoyl and dibenzoyl peroxides; dialkyl and aralkyl peroxides, such as di-tert-butyl peroxide, dicumyl peroxide, cumyl butyl peroxide, 1,1-di-tert-butylperoxy-3,5,5-trimethylcyclohexane, 2,5-dimethyl-2,5-di-tert-butylperoxyhexane, and bis(alpha-tert-butyl peroxyisopropyl-benzene); peroxy esters, such as tert-butylperoxy pivalate, tert-butyl perbenzoate, tert-butyl peroctoate; 2,5-dimethylhexyl 2,5-di(perbenzoate), tert-butyl di(perphthalate), tert-butylperoxy-2-ethyl hexanoate; 1,1-dimethyl-3-hydroxybutylperoxy-2-ethyl hexanoate; peroxy carbonates, such as di(2-ethylhexyl)peroxy dicarbonate, di(n-propyl)peroxy dicarbonate, and di(4-tert-butylcyclohexyl)peroxy dicarbonate; combinations thereof, and the like. Peroxy esters may be useful in some embodiments.

In embodiments, an initiator which may be utilized may be 2-2′-azobis(dimethyl-valeronitrile), azobis(isobutyronitrile), azobis(cyclohexane-nitrile), azobis(methyl-butyronitrile), benzoyl peroxide, lauroyl peroxide, methyl ethyl ketone peroxide, isopropyl peroxy-carbonate, 2,5-dimethyl-2,5-bis(2-ethylhexanoyl-peroxy)hexane, di-tert-butyl peroxide, cumene hydroperoxide, dichlorobenzoyl peroxide, potassium persulfate, ammonium persulfate, combinations thereof, and the like.

Other initiation mechanisms may be utilized including, for example, nonchemical initiations mechanisms such as ultrasound, ultraviolet light, ionizing radiation, combinations thereof, and the like.

In embodiments the graft copolymer may be formed by a free radical polymerization, optionally in the presence of a free radical initiator.

Where an initiator is utilized, the initiator may be present in an amount of from about 0.001 percent by weight to about 10 percent by weight of the monomers utilized to form the graft copolymer, in embodiments from about 0.01 percent by weight to about 5 percent by weight of the monomers utilized to form the graft copolymer.

In embodiments, chain transfer agents may also be utilized in grafting a monomer onto a polyester backbone at a point of unsaturation. Suitable chain transfer agents include, but are not limited to, alcohols such as isopropanol and diacetone alcohol, thiols such as octanethiol (which may be also referred to, in embodiments, as octyl mercaptan), mercaptoethanol, organohalides such as chloroform, dimers of alpha-methyl styrene, carbon tetrachloride, alkyl bromides, thiopropionic compounds, combinations thereof, and the like.

Where a chain transfer agent is utilized, the chain transfer agent may be present in an amount of from about 0.1 percent by weight to about 10 percent by weight of the monomers utilized to form the graft copolymer, in embodiments from about 0.5 percent by weight to about 2 percent by weight of the monomers utilized to form the graft copolymer.

In embodiments, the grafting reaction may occur in the presence of a solvent. Suitable solvents include, but are not limited to, tetrahydrofuran (THF), methylethyl ketone (MEK), isopropanol (IPA) dimethyl sulfoxide (DMSO), dimethylformamide (DMF), pyridine, ethyl acetate, acetone, combinations thereof, and the like. Where utilized the grafting monomers and polyester resins may be present in the solvent at a concentration of from about 10 to about 95% by weight of the solution, in embodiments from about 70 to about 90% by weight of the solution

The grafting reaction may occur by combining the grafting monomers and unsaturated polyester resins for a period of time of from about 30 minutes to about 5 hours, in embodiments from about 1 hour to about 4 hours, at a temperature of from about 60° C. to about 100° C., in embodiments from about 70° C. to about 80° C. In some embodiments the reaction may occur at a temperature of about 75° C. for a period of about 3 hours. In some embodiments the grafting monomers and polyester resins may be combined by mixing at a speed of from about 75 rpm to about 1000 rpm, in embodiments from about 100 rpm to about 500 rpm.

In embodiments, an acrylic monomer such as acrylic acid may be grafted to the backbone of an unsaturated polyester possessing fumaric acid units. With a high enough loading of fumaric acid units, which are converted to carboxyl groups after grafting, the resulting graft copolymer polyesters can be dispersed in water to form a stable aqueous dispersion. The resulting polyester particles may include a core containing the polyester surrounded by a carboxyl functionalized shell which stabilizes the particles in water.

For example, varying the molar loading of the unsaturated monomer in the polyester resin may influence the dispersibility of the grafted resin in water. For example, a polyester containing about 1 mol % of fumaric acid with grafted carboxylic moieties will not disperse easily in water. Polyesters containing over about 3 mol % fumaric acid that are grafted with acrylic acid can form small diameter particles which will make the polyester dispersible in water. A polyester containing about 5 mol % of fumaric acid may have sufficient amount of carboxylic acid groups to allow optimal dispersibility in water. Therefore, increasing the amount of fumaric acid copolymerized in the polyester chain may decrease the diameter of particles. The increase in unsaturated monomers in the polyester chain may thus increase the amount of unsaturated bonds in the polyester backbone, thereby enhancing the availability of grafting sites for the acid.

In embodiments, an exemplary grafting process may include the following. Acrylic monomers, such as acrylic acid (AA) and methacrylic acid (MAA), may be grafted onto a polyester utilizing 2,2′-azobis(isobutyronitrile) (AIBN) as an initiator in an effort to increase the acid value or carboxylic functionality along the polymer backbone of a polyester which, in turn, increases the dispersibility of the polyester in water. The general grafting mechanism, which may be initiated by primary and/or polymer radical attack on the backbone polymer, and the resulting particles possessing a carboxyl shell as described above, are summarized in the FIGURE.

A polyester resin that has been subjected to the grafting reaction of the present disclosure may have an acid number of from about 10 milliequivalents of potassium hydroxide per gram of resin to about 1000 milliequivalents of potassium hydroxide per gram of resin, in embodiments from about 12 milliequivalents of potassium hydroxide per gram of resin to about 100 milliequivalents of potassium hydroxide per gram of resin.

The higher acid number obtained may play an important role in the dispersibility of the resin in water and may result in latex particles having a small particle diameter of from about 20 nm to about 1000 nm, in embodiments from about 100 nm to about 300 nm. As the higher acid number results in the latex resins of the present disclosure being self-dispersible in water, the use of such a latex resin may reduce the need for and/or amount of solvents used in manufacturing toner particles, thus resulting in more environmentally friendly processes. The higher acid number of the latex resins also corresponds to excellent charging performance for toners produced with these resins, and may result in toners having excellent resistivity and cohesion characteristics.

### Toner

The resin described above may be utilized to form toner compositions. Such toner compositions may include optional colorants, waxes, and other additives. Toners may be formed utilizing any method within the purview of those skilled in the art.

### Surfactants

In embodiments, colorants, waxes, and other additives utilized to form toner compositions may be in dispersions including surfactants. Moreover, toner particles may be formed by emulsion aggregation methods where the resin and other components of the toner are placed in one or more surfactants, an emulsion is formed, toner particles are aggregated, coalesced, optionally washed and dried, and recovered.

One, two, or more surfactants may be utilized. The surfactants may be selected from ionic surfactants and nonionic surfactants. Anionic surfactants and cationic surfactants are encompassed by the term “ionic surfactants.” In embodiments, the surfactant may be utilized so that it is present in an amount of from about 0.01% to about 5% by weight of the toner composition, for example from about 0.75% to about 4% by weight of the toiler composition, in embodiments from about 1% to about 3% by weight of the toner composition.

Examples of nonionic surfactants that can be utilized include, for example, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy)ethanol, available from Rhone-Poulenac as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™. Other examples of suitable nonionic surfactants include a block copolymer of polyethylene oxide and polypropylene oxide, including those commercially available as SYNPERONIC PE/F, in embodiments SYNPERONIC PE/F 108™.

Anionic surfactants which may be utilized include sulfates and sulfonates, sodium dodecylsulfate (SDS), sodium dodecylbenzene sulfonate, sodium dodecylnaphthalene sulfate, dialkyl benzenealkyl sulfates and sulfonates, acids such as abitic acid available from Aldrich, NEOGEN R™, NEOGEN SC™ obtained from Daiichi Kogyo Seiyaku, combinations thereof, and the like. Other suitable anionic surfactants include, in embodiments, DOWFAX™ 2A1, an alkyldiphenyloxide disulfonate from The Dow Chemical Company, and/or TAYCA POWER BN2060 from Tayca Corporation (Japan), which are branched sodium dodecyl benzene sulfonates. Combinations of these surfactants and any of the foregoing anionic surfactants may be utilized in embodiments.

Examples of the cationic surfactants, which are usually positively charged, include, for example, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂, C₁₅, C₁₇ trimethyl ammonium bromides, halide salts of quaternized polyoxyethylalkylamines, dodecylbenzyl triethyl ammonium chloride, MIRAPOL™ and ALKAQUAT™, available from Alkaril Chemical Company, SANIZOL™ (benzalkonium chloride), available from Kao Chemicals, and the like, and mixtures thereof.

### Colorants

As the colorant to be added, various known suitable colorants, such as dyes, pigments, mixtures of dyes, mixtures of pigments, mixtures of dyes and pigments, and the like, may be included in the toner. The colorant may be included in the toner in an amount of for example, about 0.1 to about 35 percent by weight of the toner, or from about 1 to about 15 weight percent of the toner, or from about 3 to about 10 percent by weight of the toner.

As examples of suitable colorants, mention may be made of carbon black like REGAL 330™; magnetites, such as Mobay magnetites MO8029™, MO8060™; Columbian magnetites; MAPICO BLACKS™ and surface treated magnetites; Pfizer magnetites CB4799™, CB5300™, CB5600™, MCX6369™; Bayer magnetites, BAYFERROX 8600™, 8610™; Northern Pigments magnetites, NP-604™, NP-608™; Magnox magnetites TMB-100™, or TMB-104™; and the like. As colored pigments, there can be selected cyan, magenta, yellow, red, green, brown, blue or mixtures thereof. Generally, cyan, magenta, or yellow pigments or dyes, or mixtures thereof, are used. The pigment or pigments are generally used as water based pigment dispersions.

Specific examples of pigments include SUNSPERSE 6000, FLEXIVERSE and AQUATONE water based pigment dispersions from SUN Chemicals, HELIOGEN BLUE L6900™, D6840™, D7080™, D7020™, PYLAM OIL BLUE™, PYLAM OIL YELLOW™, PIGMENT BLUE 1™ available from Paul Uhlich & Company, Inc., PIGMENT VIOLET 1™, PIGMENT RED 48™. LEMON CHROME YELLOW DCC 1026™, E.D. TOLUIDINE RED™ and BON RED C™ available from Dominion Color Corporation, Ltd., Toronto, Ontario, NOVAPERM YELLOW FGL™, HOSTAPERM PINK E™ from Hoechst, and CINQUASIA MAGENTA™ available from E.I. DuPont de Nemours & Company, and the like. Generally, colorants that can be selected are black, cyan, magenta, or yellow, and mixtures thereof. Examples of magentas are 2,9-dimethyl-substituted quinacridone and anthraquinone dye identified in the Color Index as CI 60710, CI Dispersed Red 15, diazo dye identified in the Color Index as CI-26050, CI Solvent Red 19, and the like. Illustrative examples of cyans include copper tetra(octadecyl sulfonamido)phthalocyanine, x-copper phthalocyanine pigment listed in the Color Index as CI 74160, CI Pigment Blue, Pigment Blue 15:3, and Anthrathrene Blue, identified in the Color Index as CI-69810, Special Blue X-2137, and the like. Illustrative examples of yellows are diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,5-dimethoxy acetoacetanilide, and Permanent Yellow FGL. Colored magnetites, such as mixtures of MAPICO BLACK™, and cyan components may also be selected as colorants. Other known colorants can be selected, such as Levanyl Black A-SF (Miles, Bayer) and Sunsperse Carbon Black LHD 9303 (Sun Chemicals), and colored dyes such as Neopen Blue (BASF), Sudan Blue OS (BASF), PV Fast Blue B2G01 (American Hoechst). Sunsperse Blue BHD 6000 (Sun Chemicals). Irgalite Blue BCA (Ciba-Geigy), Paliogen Blue 6470 (BASF), Sudan III (Matheson, Coleman, Bell), Sudan II (Matheson, Coleman, Bell), Sudan IV (Matheson, Coleman, Bell), Sudan Orange G (Aldrich), Sudan Orange 220 (BASF), Paliogen Orange 3040 (BASF), Ortho Orange OR2673 (Paul Uhlich), Paliogen Yellow 152, 1560 (BASF), Lithol Fast Yellow 0991K (BASF), Paliotol Yellow 1840 (BASF), Neopen Yellow (BASF), Novoperm Yellow FG 1 (Hoechst), Permanent Yellow YE 0305 (Paul Uhlich), Lumogen Yellow D0790 (BASF), Sunsperse Yellow YHD 6001 (Sun Chemicals), Suco-Gelb L1250 (BASF), Suco-Yellow D1355 (BASF), Hostaperm Pink E (American Hoechst), Fanal Pink D4830 (BASF), Cinquasia Magenta (DuPont), Lithol Scarlet D3700 (BASF), Toluidine Red (Aldrich), Scarlet for Thermoplast NSD PS PA (Ugine Kuhlmann of Canada), E.D. Toluidine Red (Aldrich), Lithol Rubine Toner (Paul Uhlich), Lithol Scarlet 4440 (BASF), Bon Red C (Dominion Color Company), Royal Brilliant Red RD-8192 (Paul Uhlich), Oracet Pink RF (Ciba-Geigy), Paliogen Red 3871K (BASF), Paliogen Red 3340 (BASF), Lithol Fast Scarlet L4300 (BASF), combinations of the foregoing, and the like.

### Wax

Optionally, a wax may also be combined with the resin and a colorant in forming toner particles. When included, the wax may be present in an amount of, for example, from about 1 weight percent to about 25 weight percent of the toner particles, in embodiments from about 5 weight percent to about 20 weight percent of the toner particles.

Waxes that may be selected include waxes having, for example, a weight average molecular weight of from about 500 to about 20,000, in embodiments from about 1,000 to about 10,000. Waxes that may be used include, for example, polyolefins such as polyethylene, polypropylene, and polybutene waxes such as commercially available from Allied Chemical and Petrolite Corporation, for example POLYWAX™ polyethylene waxes from Baker Petrolite, wax emulsions available from Michaelman, Inc. and the Daniels Products Company, EPOLENE N-15™ commercially available from Eastman Chemical Products, Inc., and VISCOL 550-P™, a low weight average molecular weight polypropylene available from Sanyo Kasei K. K.; plant-based waxes, such as carnauba wax, rice wax, candelilla wax, sumacs wax, and jojoba oil; animal-based waxes, such as beeswax; mineral-based waxes and petroleum-based waxes, such as montan wax, ozokerite, ceresin, paraffin wax, microcrystalline wax, and Fischer-Tropsch wax; ester waxes obtained from higher fatty acid and higher alcohol, such as stearyl stearate and behenyl behenate; ester waxes obtained from higher fatty acid and monovalent or multivalent lower alcohol, such as butyl stearate, propyl oleate, glyceride monostearate, glyceride distearate, and pentaerythritol tetra behenate; ester waxes obtained from higher fatty acid and multivalent alcohol multimers, such as diethyleneglycol monostearate, dipropyleneglycol distearate, diglyceryl distearate, and triglyceryl tetrastearate; sorbitan higher fatty acid ester waxes, such as sorbitan monostearate, and cholesterol higher fatty acid ester waxes, such as cholesteryl stearate. Examples of functionalized waxes that may be used include, for example, amines, amides, for example AQUA SUPERSLIP 6550™, SUPERSLIP 6530™ available from Micro Powder Inc., fluorinated waxes, for example POLYFLUO 190™, POLYFLUO 200™, POLYSILK 19™, POLYSILK 14™ available from Micro Powder Inc., mixed fluorinated, amide waxes, for example MICROSPERSION 19™ also available from Micro Powder Inc., imides, esters, quaternary amines, carboxylic acids or acrylic polymer emulsion, for example JONCRYL 74™, 89™, 130™, 537™, and 538™, all available from SC Johnson Wax, and chlorinated polypropylenes and polyethylenes available from Allied Chemical and Petrolite Corporation and SC Johnson wax. Mixtures and combinations of the foregoing waxes may also be used in embodiments. Waxes may be included as, for example, fuser roll release agents.

### Toner Preparation

The toner particles may be prepared by any method within the purview of one skilled in the art. Although embodiments relating to toner particle production are described below with respect to emulsion-aggregation processes, any suitable method of preparing toner particles may be used, including chemical processes, such as suspension and encapsulation processes disclosed in U.S. Pat. Nos. 5,290,654 and 5,302,486, the disclosures of each of which are hereby incorporated by reference in their entirety. In embodiments, toner compositions and toner particles may be prepared by aggregation and coalescence processes in which small-size resin particles are aggregated to the appropriate toner particle size and then coalesced to achieve the final toner particle shape and morphology.

In embodiments, toner compositions may be prepared by emulsion-aggregation processes, such as a process that includes aggregating a mixture of an optional colorant, an optional wax and any other desired or required additives, and emulsions including the graft copolymer resins described above, optionally in surfactants as described above, and then coalescing the aggregate mixture. A mixture may be prepared by adding a colorant and optionally a wax or other materials, which may also be optionally in a dispersion(s) including a surfactant, to the emulsion, which may be a mixture of two or more emulsions containing the resin. The pH of the resulting mixture may be adjusted by an acid such as, for example, acetic acid, nitric acid or the like. In embodiments, the pH of the mixture may be adjusted to from about 4 to about 5. Additionally, in embodiments, the mixture may be homogenized. If the mixture is homogenized, homogenization may be accomplished by mixing at about 600 to about 4,000 revolutions per minute. Homogenization may be accomplished by any suitable means, including, for example, an IKA ULTRA TURRAX T50 probe homogenizer.

Following the preparation of the above mixture, an aggregating agent may be added to the mixture. Any suitable aggregating agent may be utilized to form a toner. Suitable aggregating agents include, for example, aqueous solutions of a divalent cation or a multivalent cation material. The aggregating agent may be, for example, polyaluminum halides such as polyaluminum chloride (PAC), or the corresponding bromide, fluoride, or iodide, polyaluminum silicates such as polyaluminum sulfosilicate (PASS), and water soluble metal salts including aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper chloride, copper sulfate, and combinations thereof. In embodiments, the aggregating agent may be added to the mixture at a temperature that is below the glass transition temperature (Tg) of the resin.

The aggregating agent may be added to the mixture utilized to form a toner in an amount of, for example, from about 0.1% to about 8% by weight, in embodiments from about 0.2% to about 5% by weight, in other embodiments from about 0.5% to about 5% by weight, of the resin in the mixture. This provides a sufficient amount of agent for aggregation.

In order to control aggregation and coalescence of the particles, in embodiments the aggregating agent may be metered into the mixture over time. For example, the agent may be metered into the mixture over a period of from about 5 to about 240 minutes, in embodiments from about 30 to about 200 minutes, although more or less time may be used as desired or required. The addition of the agent may also be done while the mixture is maintained under stirred conditions, in embodiments from about 50 rpm to about 1,000 rpm, in other embodiments from about 100 rpm to about 500 rpm, and at a temperature that is below the glass transition temperature of the resin as discussed above, in embodiments from about 30° C. to about 90° C., in embodiments from about 35° C. to about 70° C.

The particles may be permitted to aggregate and/or coalesce until a predetermined desired particle size is obtained. A predetermined desired size refers to the desired particle size to be obtained as determined prior to formation, and the particle size being monitored during the growth process until such particle size is reached. Samples may be taken during the growth process and analyzed, for example with a Coulter Counter, for average particle size. The aggregation/coalescence thus may proceed by maintaining the elevated temperature, or slowly raising the temperature to, for example, from about 40° C. to about 100° C., and holding the mixture at this temperature for a time from about 0.5 hours to about 6 hours, in embodiments from about hour 1 to about 5 hours, while maintaining stirring, to provide the aggregated particles. Once the predetermined desired particle size is reached, then the growth process is halted. In embodiments, the predetermined desired particle size is within the toner particle size ranges mentioned above.

The growth and shaping of the particles following addition of the aggregation agent may be accomplished under any suitable conditions. For example, the growth and shaping may be conducted under conditions in which aggregation occurs separate from coalescence. For separate aggregation and coalescence stages, the aggregation process may be conducted under shearing conditions at an elevated temperature, for example of from about 40° C. to about 90° C., in embodiments from about 45° C. to about 80° C., which may be below the glass transition temperature of the resin as discussed above.

### Shell Resin

In embodiments, an optional shell may be applied to the formed aggregated toner particles prior to coalescence. Any resin described above as suitable for the toner resin may be utilized as the shell resin. The shell resin may be applied to the aggregated particles by any method within the purview of those skilled in the art. In embodiments, the shell resin may be in an emulsion including any surfactant described above. The aggregated particles described above may be combined with said emulsion so that the resin forms a shell over the formed aggregates. In embodiments, an amorphous polyester may be utilized to form a shell over the aggregates to form toner particles having a core-shell configuration.

Once the desired final size of the toner particles is achieved, the pH of the mixture may be adjusted with a base to a value of from about 3 to about 10, and in embodiments from about 5 to about 9. The adjustment of the pH may be utilized to freeze, that is to stop, toner growth. The base utilized to stop toner growth may include any suitable base such as, for example, alkali metal hydroxides such as, for example, sodium hydroxide, potassium hydroxide, ammonium hydroxide, combinations thereof, and the like. In embodiments, ethylene diamine tetraacetic acid (EDTA) may be added to help adjust the pH to the desired values noted above.

Following aggregation to the desired particle size, and optional formation of a shell, the particles may then be coalesced to the desired final shape, the coalescence being achieved by, for example, heating the mixture to a temperature of from about 65° C. to about 105° C., in embodiments from about 70° C. to about 95° C., which may be at or above the glass transition temperature of the resin, and/or increasing the stirring, for example to from about 400 rpm to about 1,000 rpm, in embodiments from about 500 rpm to about 800 rpm. Higher or lower temperatures may be used, it being understood that the temperature is a function of the resins used for the binder. Coalescence may be accomplished over a period of from about 0.1 to about 9 hours, in embodiments from about 0.5 to about 4 hours.

After aggregation and/or coalescence, the mixture may be cooled to room temperature, such as from about 20° C. to about 25° C. The cooling may be rapid or slow, as desired. A suitable cooling method may include introducing cold water to a jacket around the reactor. After cooling, the toner particles may be optionally washed with water, and then dried. Drying may be accomplished by any suitable method for drying including, for example, freeze-drying.

### Additives

In embodiments, the toner particles may also contain other optional additives, as desired or required. For example, the toner may include positive or negative charge control agents, for example in an amount of from about 0.1 to about 10 percent by weight of the toner, in embodiments from about 1 to about 3 percent by weight of the toner. Examples of suitable charge control agents include quaternary ammonium compounds inclusive of alkyl pyridinium halides; bisulfates; alkyl pyridinium compounds, including those disclosed in U.S. Pat. No. 4,298,672, the disclosure of which is hereby incorporated by reference in its entirety; organic sulfate and sulfonate compositions, including those disclosed in U.S. Pat. No. 4,338,390, the disclosure of which is hereby incorporated by reference in its entirety; cetyl pyridinium tetrafluoroborates; distearyl dimethyl ammonium methyl sulfate; aluminum salts such as BONTRON E84™ or E88™ (Hodogaya Chemical); combinations thereof, and the like. Such charge control agents may be applied simultaneously with the shell resin described above or after application of the shell resin.

There can also be blended with the toner particles external additive particles including flow aid additives, which additives may be present on the surface of the toner particles. Examples of these additives include metal oxides such as titanium oxide, silicon oxide, tin oxide, mixtures thereof, and the like; colloidal and amorphous silicas such as AEROSIL®, metal salts and metal salts of fatty acids inclusive of zinc stearate, aluminum oxides, cerium oxides, and mixtures thereof. Each of these external additives may be present in an amount of from about 0.1 percent by weight to about 5 percent by weight of the toner, in embodiments of from about 0.25 percent by weight to about 3 percent by weight of the toner. Suitable additives include those disclosed in U.S. Pat. Nos. 3,590,000, 3,800,588, and 6,214,507, the disclosures of each of which are hereby incorporated by reference in their entirety. Again, these additives may be applied simultaneously with the shell resin described above or after application of the shell resin.

In embodiments, toners of the present disclosure may be utilized as ultra low melt (ULM) toners. In embodiments, the dry toner particles, exclusive of external surface additives, may have the following characteristics:

(1) Volume average diameter (also referred to as “volume average particle diameter”) of from about 3 to about 20 μm, in embodiments from about 4 to about 15 μm, in other embodiments from about 5 to about 9 μm.

(2) Number Average Geometric Standard Deviation (GSDn) and/or Volume Average Geometric Standard Deviation (GSDv) of from about 1.05 to about 1.55, in embodiments from about 1.1 to about 1.4.

(3) Circularity of from about 0.9 to about 1 (measured with, for example, a Sysmex FPIA 2100 analyzer), in embodiments form about 0.95 to about 0.985, in other embodiments from about 0.96 to about 0.98.

(4) Glass transition temperature of from about 40° C. to about 65° C., in embodiments from about 55° C. to about 62° C.

The characteristics of the toner particles may be determined by any suitable technique and apparatus. Volume average particle diameter D₅₀ᵥ, GSDv, and GSDn may be measured by means of a measuring instrument such as a Beckman Coulter Multisizer 3, operated in accordance with the manufacturer's instructions. Representative sampling may occur as follows: a small amount of toner sample, about 1 gram, may be obtained and filtered through a 25 micrometer screen, then put in isotonic solution to obtain a concentration of about 10%, with the sample then run in a Beckman Coulter Multisizer 3.

Toners produced in accordance with the present disclosure may possess excellent charging characteristics when exposed to extreme relative humidity (RH) conditions. The low-humidity zone (C zone) may be about 10° C./15% RH, while the high humidity zone (A zone) may be about 28° C./85% RH. Toners of the present disclosure may also possess a parent toner charge per mass ratio (Q/M) of from about −3 μC/g to about −35 μC/g, and a final toner charging after surface additive blending of from −10 μC/g to about −45 μC/g.

In accordance with the present disclosure, the charging of the toner particles may be enhanced, so less surface additives may be required, and the final toner charging may thus be higher to meet machine charging requirements.

### Developers

The toner particles may be formulated into a developer composition. The toner particles may be mixed with carrier particles to achieve a two-component developer composition. The toner concentration in the developer may be from about 1% to about 25% by weight of the total weight of the developer, in embodiments from about 2% to about 15% by weight of the total weight of the developer.

### Carriers

Examples of carrier particles that can be utilized for mixing with the toner include those particles that are capable of triboelectrically obtaining a charge of opposite polarity to that of the toner particles. Illustrative examples of suitable carrier particles include granular zircon, granular silicon, glass, steel, nickel, ferrites, iron ferrites, silicon dioxide, and the like. Other carriers include those disclosed in U.S. Pat. Nos. 3,847,604, 4,937,166, and 4,935,326.

The selected carrier particles can be used with or without a coating. In embodiments, the carrier particles may include a core with a coating thereover which may be formed from a mixture of polymers that are not in close proximity thereto in the triboelectric series. The coating may include fluoropolymers, such as polyvinylidene fluoride resins, terpolymers of styrene, methyl methacrylate, and/or silanes, such as triethoxy silane, tetrafluoroethylenes, other known coatings and the like. For example, coatings containing polyvinylidenefluoride, available, for example, as KYNAR 301F™, and/or polymethylmethacrylate, for example having a weight average molecular weight of about 300,000 to about 350,000, such as commercially available from Soken, may be used. In embodiments, polyvinylidenefluoride and polymethylmethacrylate (PMMA) may be mixed in proportions of from about 30 to about 70 weight % to about 70 to about 30 weight %, in embodiments from about 40 to about 60 weight % to about 60 to about 40 weight %. The coating may have a coating weight of, for example, from about 0.1 to about 5% by weight of the carrier, in embodiments from about 0.5 to about 2% by weight of the carrier.

In embodiments, PMMA may optionally be copolymerized with any desired comonomer, so long as the resulting copolymer retains a suitable particle size. Suitable comonomers can include monoalkyl, or dialkyl amines, such as a dimethylaminoethyl methacrylate, diethylaminoethyl methacrylate, diisopropylaminoethyl methacrylate, or t-butylaminoethyl methacrylate, and the like. The carrier particles may be prepared by mixing the carrier core with polymer in an amount from about 0.05 to about 10 percent by weight, in embodiments from about 0.01 percent to about 3 percent by weight, based on the weight of the coated carrier particles, until adherence thereof to the carrier core by mechanical impaction and/or electrostatic attraction.

Various effective suitable means can be used to apply the polymer to the surface of the carrier core particles, for example, cascade roll mixing, tumbling, milling, shaking, electrostatic powder cloud spraying, fluidized bed, electrostatic disc processing, electrostatic curtain, combinations thereof, and the like. The mixture of carrier core particles and polymer may then be heated to enable the polymer to melt and fuse to the carrier core particles. The coated carrier particles may then be cooled and thereafter classified to a desired particle size.

In embodiments, suitable carriers may include a steel core, for example of from about 25 to about 100 μm in size, in embodiments from about 50 to about 75 μm in size, coated with about 0.5% to about 10% by weight, in embodiments from about 0.7% to about 5% by weight, of a conductive polymer mixture including, for example, methylacrylate and carbon black using the process described in U.S. Pat. Nos. 5,236,629 and 5,330,874.

The carrier particles can be mixed with the toner particles in various suitable combinations. The concentrations are may be from about 1% to about 20% by weight of the toner composition. However, different toner and carrier percentages may be used to achieve a developer composition with desired characteristics.

### Imaging

The toners can be utilized for electrostatographic or xerographic processes, including those disclosed in U.S. Pat. No. 4,295,990, the disclosure of which is hereby incorporated by reference in its entirety. In embodiments, any known type of image development system may be used in an image developing device, including, for example, magnetic brush development, jumping single-component development, hybrid scavengeless development (HSD), and the like. These and similar development systems are within the purview of those skilled in the art.

Imaging processes include, for example, preparing an image with a xerographic device including a charging component, an imaging component, a photoconductive component, a developing component, a transfer component, and a fusing component. In embodiments, the development component may include a developer prepared by mixing a carrier with a toner composition described herein. The xerographic device may include a high speed printer, a black and white high speed printer, a color printer, and the like.

Once the image is formed with toners/developers via a suitable image development method such as any one of the aforementioned methods, the image may then be transferred to an image receiving medium such as paper and the like. In embodiments, the toners may be used in developing an image in an image-developing device utilizing a fuser roll member. Fuser roll members are contact fusing devices that are within the purview of those skilled in the art, in which heat and pressure from the roll may be used to fuse the toner to the image-receiving medium. In embodiments, the fuser member may be heated to a temperature above the fusing temperature of the toner, for example to temperatures of from about 70° C. to about 160° C., in embodiments from about 80° C. to about 150° C., in other embodiments from about 90° C. to about 140° C., after or during melting onto the image receiving substrate.

In embodiments where the toner resin is crosslinkable, such crosslinking may be accomplished in any suitable manner. For example, the toner resin may be crosslinked during fusing of the toner to the substrate where the toner resin is crosslinkable at the fusing temperature. Crosslinking also may be effected by heating the fused image to a temperature at which the toner resin will be crosslinked, for example in a post-fusing operation. In embodiments, crosslinking may be effected at temperatures of from about 160° C. or less, in embodiments from about 70° C. to about 160° C., in other embodiments from about 80° C. to about 140° C.

The following Examples are being submitted to illustrate embodiments of the present disclosure. These Examples are intended to be illustrative only and are not intended to limit the scope of the present disclosure. Also, parts and percentages are by weight unless otherwise indicated. As used herein, “room temperature” refers to a temperature of from about 20° C. to about 25° C.

### EXAMPLES

### Example 1

About 150 grams of methylethyl ketone and about 50 grams of isopropanol were charged in a reaction vessel with about 200 grains of an unsaturated crystalline polyester (“UCPE”) resin of ethylene glycol and a mixture of dodecanedioic acid and fumaric acid co-monomers with the following formula:

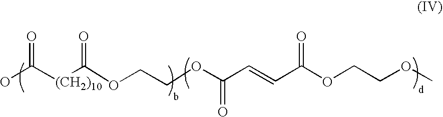

wherein b is from 5 to 2000 and d is from 5 to 2000 in an emulsion (about 19.98 weight % resin), synthesized following the procedures described in U.S. Patent Application Publication No. 2006/0222991, the disclosure of which is hereby incorporated by reference in its entirety. The vessel was placed in a heating mantle and equipped with a metal stirrer, thermometer, refluxing device, and drop funnel for inlet. The mixture was stirred under reflux at about 75° C. until the UCPE was completely dissolved.

A mixture of about 66.67 grams acrylic acid, about 4 grams azobisisobutyronitrile, and about 3.33 grams octyl mercaptan (1-octanethiol) (obtained from Sigma-Aldrich) in about 50 grains methylethyl ketone and about 16.67 grains isopropanol, was then added dropwise over about 2 hours at a rate of about 1 grain/minute, with a stir shaft speed of about 130 revolutions per minute (rpm). The reaction mixture was further reacted for about 3 hours to obtain a solution of the grafted-reaction product. A sample of the grafted-reaction product was removed from the kettle and washed in water to remove any impurities and remaining homopolymer of acrylic acid. The acid number for this sample was determined, by titrating the acid groups, to verify the presence of carboxylic acid moieties. The acid number was the number of milligrams of potassium hydroxide necessary to neutralize the free acids in 1 gram of resin.

The resulting material was a grafted unsaturated crystalline polyester (UCPE) containing about 3.92 mol % fumaric acid monomer having a mass ratio of polyester to acrylic acid of about 67:33.

### Example 2

A grafting reaction similar to Example 1 was carried out to obtain a UCPE containing about 3.92 mol % fumaric acid monomer with a mass ratio of polyester to acrylic acid of about 95:5.

About 200 grams of the UCPE described above in Example 1, about 150 grams of methylethyl ketone, and about 50 grams of isopropanol were charged in a reaction vessel. The vessel was placed in a heating mantle and equipped with a metal stirrer, thermometer, refluxing device, and drop funnel for inlet. The mixture was stirred under reflux at about 75° C. until the UCPE was completely dissolved. Then, a mixture of about 10 grams acrylic acid, about 0.6 grams azobisisobutyronitrile, and about 0.5 grams octyl mercaptan (1-octanethiol) in about 7.5 grams methylethyl ketone and about 2.5 grams isopropanol was added dropwise over about 1.5 hours at a rate of about 0.25 grams/minute with a stir shaft speed of about 250 rpm. The reaction mixture was further reacted for about 3 hours to obtain a solution of the grafted-reaction product.

A sample of the grafted-reaction product was removed from the kettle and washed in water to remove any impurities and homopolymer of acrylic acid. Acid number was determined for this sample as described above in Example 1 to verify evidence of carboxylic acid moieties.

### Example 3

A grafting reaction similar to Example 1 was carried out to obtain a UCPE containing about 3.92 mol % fumaric acid monomer with a mass ratio of polyester to acrylic acid of about 90:10.

About 200 grams of the UCPE described above in Example 1, about 150 grams of methylethyl ketone, and about 50 grams of isopropanol were charged in a reaction vessel. The vessel was placed in a heating mantle and equipped with a metal stirrer, thermometer, refluxing device, and drop funnel for inlet. The mixture was stirred under reflux at about 75° C. until the UCPE was completely dissolved. Then, a mixture of about 20 grams acrylic acid, about 1.2 grams azobisisobutyronitrile, and about 1 gram octyl mercaptan (1-octanethiol) in about 15 grams in methylethyl ketone and about 5 grams isopropanol was added dropwise over about 1.5 hours at a rate of about 0.5 grams/minute with a stir shaft speed of about 250 rpm.

The reaction mixture was further reacted for about 3 hours to obtain a solution of the grafted-reaction product. The mixture was poured into a metal pan to cool/dry. Once dried, the resin was ground in a lab scale grinder. The ground resin was heated in water to about 95° C. to dissolve impurities and then washed with water and methanol through a Buchner funnel to remove residual monomers and homopolymer of acrylic acid. A sample of the ground and washed resin was evaluated for acid number as described above in Example 1 to verify evidence of carboxylic acid moieties.

### Example 4

A grafting reaction similar to Example 1 was carried out to obtain a UCPE containing about 3.92 mol % fumaric acid monomer with a mass ratio of polyester to methacrylic acid of about 90:10.

About 200 grams of the UCPE described above in Example 1, about 150 grams of methylethyl ketone, and about 50 grams of isopropanol were charged in a reaction vessel. The vessel was placed in a heating mantle and equipped with a metal stirrer, thermometer, refluxing device, and drop funnel for inlet. The mixture was stirred under reflux at about 75° C. until the UCPE was completely dissolved. Then, a mixture of about 20 grams methacrylic acid, about 1.2 grams azobisisobutyronitrile, and about 1 gram octyl mercaptan (1-octanethiol) in about 15 grams methylethyl ketone and about 5 grams isopropanol was added dropwise over about 2 hours at a rate of about 1 gram/minute with a stir shaft speed of about 130 rpm.

The reaction mixture was further reacted for about 3 hours to obtain a solution of the grafted-reaction product. At the end of the 3 hour reaction time, the mixture was poured into a metal pan to cool/dry. Once dried, the resin was ground in a lab scale grinder. The ground resin was heated in water to about 95° C. to dissolve impurities and then washed with water and methanol through a Buchner funnel to remove residual monomers and homopolymer of methacrylic acid. A sample of the ground and washed resin was evaluated for acid number as described above in Example 1 to verify the presence of the carboxylic acid moieties.

Table 1 below shows the results obtained for the resins produced in Examples 1-4 herein which had been grafted with carboxylic acid moieties to enhance their dispersibility in water. The acid number of an untreated UCPE from Example 1 was utilized as a control.

TABLE 1

| | | Amount monomer | |
|---|---|---|---|
| | Acrylic | relative to amount | Acid Number (mL |
| Example | monomer | polyester | KOH/g polymer) |
| Control UCPE | None | 0% | 1.59 |
| Example 1 | Acrylic acid | 33% | 80.3 |
| Example 2 | Acrylic acid | 5% | 16.0 |
| Example 3 | Acrylic acid | 10% | 37.7 |
| Example 4 | Methacrylic | 10% | 37.1 |
| | acid | | |

The acid number provided an indication of how easily a polyester resin could be emulsified in water. The optimum resin would be able to disperse directly in water without using a phase inversion or solvent flash process, which both require dissolving the resin in solvents such as methylethyl ketone, isopropanol, or ethyl acetate. As can be seen from the above data, the samples produced in Examples 3 and 4 had good reproducibility in acid value when the same loading of acrylic monomer was used, even after changing the acrylic monomer type from acrylic acid to methacrylic acid. Example 1 had the highest acid number since it was reacted with the highest ratio of acrylic acid. This resin was partially dispersible in water via a phase inversion process with a bimodal particle size distribution at about 97 nm and about 614 nm.

Optimal dispersibility in water will be obtained when the mol % of fumaric acid in the unsaturated polyester is increased from 3.92 mol % to greater than 5 mol %. The increase in amount of unsaturated bonds in the polyester back bone enhances the grafting efficiency for acrylic radicals. Higher grafting efficiency will enable dispersions in water with small particle diameters.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. A process comprising:
contacting at least one unsaturated polyester resin with at least one grafting monomer selected from the group consisting of carboxylic acids, carboxylic anhydrides, styrenes, alpha methyl styrene, alkyl esters of acrylic acid, alkyl esters of methacrylic acid, and combinations thereof;
polymerizing the graft monomer and unsaturated polyester resin to form a graft copolymer possessing an acid number of from about 10 milliequivalents of potassium hydroxide per gram of resin to about 1000 milliequivalents of potassium hydroxide per gram of resin;
contacting the graft copolymer with an optional colorant, at least one surfactant, and an optional wax to form small particles in a dispersion;
aggregating the small particles;
coalescing the aggregated particles to form toner particles; and
recovering the toner particles.

2. The process according to claim 1, wherein the at least one unsaturated polyester resin is selected from the group consisting of amorphous polyester resins, crystalline polyester resins, semi-crystalline polyester resins, and combinations thereof.

3. The process according to claim 1, wherein the at least one unsaturated polyester resin possesses ethylenically unsaturated polymerizable monomers selected from the group consisting ethyl acrylate, n-butyl acrylate, isobutyl acrylate, t-butyl acrylate, 2-ethylhexyl acrylate, dodecyl acrylate, methyl methacrylate, ethyl methacrylate, n-butyl methacrylate, isobutyl methacrylate, t-butyl methacrylate, 2-ethylhexyl methacrylate, lauryl methacrylate, styrene, α-methylstyrene, vinyltoluene, p-t-butylstyrene, acrylonitrile, methacrylonitrile, glycidyl acrylate, glycidyl methacrylate, 2-hydroxyethyl acrylate, 2-hydroxypropyl acrylate, 1-methyl-2-hydroxyethyl acrylate, 2-hydroxyethyl methacrylate, 2-hydroxypropyl methacrylate, 1-methyl-2-hydroxyethyl in ethacrylate, polypropylene glycol monomethacrylate, glycerol monomethacrylate, 3-chloro-2-hydroxypropyl methacrylate, acrylic acid, methacrylic acid, crotonic acid, itaconic acid, fumaric acid, maleic acid, acrylamide, methacrylamide, N-methylolacrylamide, N-alkoxymethylacrylamide having an alkyl moiety of 1 to 14 carbon atoms, diacetone acrylamide, hydroxymethyldiacetone acrylamide, N-methylolmethacrylamide, N-alkoxymethylmethacrylamide having an alkyl moiety of 1 to 14 carbon atoms, the addition product between a polyisocyanate compound having at least one free isocyanate group and at least one isocyanate group blocked by a blocking agent and an ethylenically unsaturated compound having at least one hydroxyl group, and combinations thereof, in an amount of from about 1 mol % to about 20 mol % of the resin.

4. The process according to claim 1, wherein the grafting monomers are selected from the group consisting of acrylic acid, maleic acid, fumaric acid, citraconic acid, mesaconic acid, maleic anhydride, 4-methyl cyclohex-4-ene-1,2-dicarboxylic acid, 4-methyl cyclohex-4-ene-1,2-dicarboxylic anhydride, bicyclo(2.2.2)oct-5-ene-2,3-dicarboxylic acid, bicyclo(2.2.2)oct-5-ene-2,3-dicarboxylic anhydride, bicyclo(2.2.1)hept-5-ene-2,3-dicarboxylic acid, bicyclo(2.2.1)hept-5-ene-2,3-dicarboxylic anhydride, tetrahydrophthalic acid, tetrahydrophthalic anhydride, methylbicyclo(2.2.1)hept-5-ene-2,3-dicarboxylic acid, methylbicyclo(2.2.1)hept-5-ene-2,3-dicarboxylic anhydride, nadic anhydride, methyl nadic anhydride, himic anhydride, methyl himic anhydride, methacrylic acid, methyl acrylate, methyl methacrylate, ethyl acrylate, ethyl methacrylate, propyl acrylate, propyl methacrylate, butyl acrylate, butyl methacrylate, hydroxyethyl acrylate, hydroxyethyl methacrylate, hydroxypropyl methacrylate, acrylonitrile, methyacrylonitrile, acrylamide, methacrylamide, and combinations thereof.

5. The process according to claim 1, wherein the at least one unsaturated polyester resin and the at least one grafting monomer are contacted with an initiator selected from the group consisting of peroxides, persulfates, redox couples, azo compounds, ultrasound, ultraviolet light, ionizing radiation, and combinations thereof.

6. The process according to claim 5, wherein the initiator is selected from the group consisting of sodium persulfate, ammonium persulfate, potassium persulfate, tert-butyl hydroxy peroxide/sodium formaldehyde sulfoxylate, benzoyl peroxide, dibenzoyl peroxide, di-tert-butyl peroxide, dicumyl peroxide, cumyl butyl peroxide, 1,1-di-tert-butylperoxy-3,5,5-trimethylcyclohexane, 2,5-dimethyl-2,5-di-tert-butylperoxyhexane, bis(alpha-tert-butyl peroxyisopropyl-benzene), tert-butylperoxy pivalate, tert-butyl perbenzoate, tert-butyl peroctoate; 2,5-dimethylhexyl 2,5-di(perbenzoate), tert-butyl di(perphthalate), tert-butylperoxy-2-ethyl hexanoate, 1,1-dimethyl-3-hydroxybutylperoxy-2-ethyl hexanoate, di(2-ethylhexyl)peroxy dicarbonate, di(n-propyl)peroxy dicarbonate, di(4-tert-butylcyclohexyl)peroxy dicarbonate, and combinations thereof, in an amount of from about 0.1 percent by weight to about 10 percent by weight of the unsaturated polyester resin and graft monomer utilized to from the graft copolymer.

7. The process according to claim 1, wherein the at least one unsaturated polyester resin and the at least one grafting monomer are contacted with a chain transfer agent selected from the group consisting of isopropanol, diacetone alcohol, octanethiol, mercaptoethanol, chloroform, dimers of alpha-methyl styrene, carbon tetrachloride, alkyl bromides, thiopropionic compounds, and combinations thereof, in an amount of from about 0.1 percent by weight to about 10 percent by weight of the unsaturated polyester resin and graft monomer utilized to form the graft copolymer.

8. The process according to claim 1, wherein the weight ratio of the at least one unsaturated polyester resin to the at least one grafting monomer is from about 95:5 to about 50:50.

9. The process according to claim 1, wherein the at least one unsaturated polyester resin and the at least one grafting monomer are contacted for a period of time of from about 30 minutes to about 5 hours at a temperature of from about 60° C. to about 100° C.

10. The process according to claim 1, wherein the at least one unsaturated polyester resin and the at least one grafting monomer are contacted in a solvent selected from the group consisting of tetrahydrofuran, methylethyl ketone, isopropanol, dimethyl sulfoxide, dimethylformamide, pyridine, ethyl acetate, acetone, and combinations thereof.

11. The process according to claim 1, wherein the graft copolymer possesses an acid number of from about 12 milliequivalents of potassium hydroxide per grain of resin to about 100 milliequivalents of potassium hydroxide per gram of resin.

12. The process according to claim 1, wherein the toner particles have a size of from about 3 μm to about 15 μm and a circularity of from about 0.9 to about 1.

13. The process according to claim 1, wherein the optional colorant comprises dyes, pigments, combinations of dyes, combinations of pigments, and combinations of dyes and pigments, present in an amount of from about 0.1 to about 35 percent by weight of the toner, and the optional wax is selected from the group consisting of polyolefins, carnauba wax, rice wax, candelilla wax, sumacs wax, jojoba oil, beeswax; montan wax, ozokerite, ceresin, paraffin wax, microcrystalline wax, Fischer-Tropsch wax, stearyl stearate, behenyl behenate, butyl stearate, propyl oleate, glyceride monostearate, glyceride distearate, pentaerythritol tetra behenate, diethyleneglycol monostearate, dipropyleneglycol distearate, diglyceryl distearate, triglyceryl tetrastearate, sorbitan monostearate, cholesteryl stearate, and combinations thereof, present in an amount from about 1 weight percent to about 25 weight percent of the toner.

14. A process comprising:
contacting at least one unsaturated polyester resin selected from the group consisting of amorphous polyester resins, crystalline polyester resins, semi-crystalline polyester resins, and combinations thereof, with at least one grafting monomer selected from the group consisting of acrylic acid, maleic acid, fumaric acid, citraconic acid, mesaconic acid, maleic anhydride, 4-methyl cyclohex-4-ene-1,2-dicarboxylic acid, 4-methyl cyclohex-4-ene-1,2-dicarboxylic anhydride, bicyclo(2.2.2)oct-5-ene-2,3-dicarboxylic acid, bicyclo(2.2.2)oct-5-ene-2,3-dicarboxylic anhydride, bicyclo(2.2.1)hept-5-ene-2,3-dicarboxylic acid, bicyclo(2.2.1)hept-5-ene-2,3-dicarboxylic anhydride, tetrahydrophthalic acid, tetrahydrophthalic anhydride, methylbicyclo(2.2.1)hept-5-ene-2,3-dicarboxylic acid, methylbicyclo(2.2.1)hept-5-ene-2,3-dicarboxylic anhydride, nadic anhydride, methyl nadic anhydride, himic anhydride, methyl himic anhydride, methacrylic acid, methyl acrylate, methyl methacrylate, ethyl acrylate, ethyl methacrylate, propyl acrylate, propyl methacrylate, butyl acrylate, butyl methacrylate, hydroxyethyl acrylate, hydroxyethyl methacrylate, hydroxypropyl methacrylate, acrylonitrile, methyacrylonitrile, acrylamide, methacrylamide, and combinations thereof, and at least one initiator selected from the group consisting of peroxides, persulfates, redox couples, azo compounds, ultrasound, ultraviolet light, ionizing radiation and combinations thereof;
polymerizing the graft monomer and unsaturated polyester resin for a period of time of from about 30 minutes to about 5 hours at a temperature of from about 60° C. to about 100° C. to form a graft copolymer possessing an acid number of from about 10 milliequivalents of potassium hydroxide per gram of resin to about 1000 milliequivalents of potassium hydroxide per gram of resin;
contacting the graft copolymer with an optional colorant, at least one surfactant, and an optional wax to form small particles in a dispersion;
aggregating the small particles;
coalescing the aggregated particles to form toner particles; and
recovering the toner particles.

15. The process according to claim 14, wherein the at least one unsaturated polyester resin possesses ethylenically unsaturated polymerizable monomers selected from the group consisting ethyl acrylate n-butyl acrylate, isobutyl acrylate, t-butyl acrylate, 2-ethylhexyl acrylate, dodecyl acrylate, methyl methacrylate, ethyl methacrylate, n-butyl methacrylate, isobutyl methacrylate, t-butyl methacrylate, 2-ethylhexyl methacrylate, lauryl methacrylate, styrene, α-methylstyrene, vinyltoluene, p-t-butylstyrene, acrylonitrile, methacrylonitrile, glycidyl acrylate, glycidyl methacrylate, 2-hydroxyethyl acrylate, 2-hydroxypropyl acrylate, 1-methyl-2-hydroxyethyl acrylate, 2-hydroxyethyl methacrylate, 2-hydroxypropyl methacrylate, 1-methyl-2-hydroxyethyl methacrylate, polypropylene glycol monomethacrylate, glycerol monomethacrylate, 3-chloro-2-hydroxypropyl methacrylate, acrylic acid, methacrylic acid, crotonic acid, itaconic acid, fumaric acid, maleic acid, acrylamide, methacrylamide, N-methylolacrylamide, N-alkoxymethylacrylamide having an alkyl moiety of 1 to 14 carbon atoms, diacetone acrylamide, hydroxymethyldiacetone acrylamide, N-methylolmethacrylamide, N-alkoxymethylmethacrylamide having an alkyl moiety of 1 to 14 carbon atoms, the addition product between a polyisocyanate compound having at least one free isocyanate group and at least one isocyanate group blocked by a blocking agent and an ethylenically unsaturated compound having at least one hydroxyl group, and combinations thereof, in an amount of from about 1 mol % to about 20 mol % of the resin, and
wherein the weight ratio of the at least one unsaturated polyester resin to the at least one grafting monomer is from about 95:5 to about 50:50.

16. The process according to claim 14, wherein the initiator is selected from the group consisting of sodium persulfate, ammonium persulfate, potassium persulfate, tert-butyl hydroxy peroxide/sodium formaldehyde sulfoxylate, benzoyl peroxide, dibenzoyl peroxide, di-tert-butyl peroxide, dicumyl peroxide, cumyl butyl peroxide, 1,1-di-tert-butylperoxy-3,5,5-trimethylcyclohexane, 2,5-dimethyl-2,5-di-tert-butylperoxyhexane, bis(alpha-tert-butyl peroxyisopropyl-benzene), tert-butylperoxy pivalate, tert-butyl perbenzoate, tert-butyl peroctoate; 2,5-dimethylhexyl 2,5-di(perbenzoate), tert-butyl di(perphthalate), tert-butylperoxy-2-ethyl hexanoate, 1,1-dimethyl-3-hydroxybutylperoxy-2-ethyl hexanoate, di(2-ethylhexyl)peroxy dicarbonate, di(n-propyl)peroxy dicarbonate, di(4-tert-butylcyclohexyl)peroxy dicarbonate, and combinations thereof, present in an amount of from about 0.1 percent by weight to about 10 percent by weight of the unsaturated polyester resin and graft monomer utilized to form the graft copolymer.

17. The process according to claim 14, wherein the at least one unsaturated polyester resin and the at least one grafting monomer are contacted with a chain transfer agent selected from the group consisting of isopropanol, diacetone alcohol, octanethiol, mercaptoethanol, chloroform dimers of alpha-methyl styrene, carbon tetrachloride, alkyl bromides, thiopropionic compounds, and combinations thereof, in an amount of from about 0.1 percent by weight to about 10 percent by weight of the unsaturated polyester resin and graft monomer utilized to form the graft copolymer.

18. The process according to claim 14, wherein the toner particles have a volume average diameter of from about 3 μm to about 15 μm and a circularity of from about 0.9 to about 1.

19. A toner comprising at least one resin comprising a graft copolymer comprising:
at least one unsaturated polyester resin possessing ethylenically unsaturated polymerizable monomers selected from the group consisting ethyl acrylate, n-butyl acrylate, isobutyl acrylate, t-butyl acrylate, 2-ethylhexyl acrylate, dodecyl acrylate, methyl methacrylate, ethyl methacrylate, n-butyl methacrylate, isobutyl methacrylate, t-butyl methacrylate, 2-ethylhexyl methacrylate, lauryl methacrylate, styrene, α-methylstyrene, vinyltoluene, p-t-butylstyrene, acrylonitrile, methacrylonitrile, glycidyl acrylate, glycidyl methacrylate, 2-hydroxyethyl acrylate, 2-hydroxypropyl acrylate, 1-methyl-2-hydroxyethyl acrylate, 2-hydroxyethyl methacrylate, 2-hydroxypropyl methacrylate, 1-methyl-2-hydroxyethyl methacrylate, polypropylene glycol monomethacrylate, glycerol monomethacrylate, 3-chloro-2-hydroxypropyl methacrylate, acrylic acid, methacrylic acid, crotonic acid, itaconic acid, fumaric acid, maleic acid, acrylamide, methacrylamide, N-methylolacrylamide, N-alkoxymethylacrylamide having an alkyl moiety of 1 to 14 carbon atoms, diacetone acrylamide, hydroxymethyldiacetone acrylamide, N-methylolmethacrylamide, N-alkoxymethylmethacrylamide having an alkyl moiety of 1 to 14 carbon atoms, the addition product between a polyisocyanate compound having at least one free isocyanate group and at least one isocyanate group blocked by a blocking agent and an ethylenically unsaturated compound having at least one hydroxyl group, and combinations thereof, present in an amount of from about 1 mol % to about 20 mol % of the resin;
at least one grafting monomer selected from the group consisting of acrylic acid, maleic acid, fumaric acid, citraconic acid, mesaconic acid, maleic anhydride, 4-methyl cyclohex-4-ene-1,2-dicarboxylic acid, 4-methyl cyclohex-4-ene-1,2-dicarboxylic anhydride, bicyclo(2.2.2)oct-5-ene-2,3-dicarboxylic acid, bicyclo(2.2.2)oct-5-ene-2,3-dicarboxylic anhydride, bicyclo(2.2.1)hept-5-ene-2,3-dicarboxylic acid, bicyclo(2.2.1)hept-5-ene-2,3-dicarboxylic anhydride, tetrahydrophthalic acid, tetrahydrophthalic anhydride, methylbicyclo(2.2.1)hept-5-ene-2,3-dicarboxylic acid, methylbicyclo(2.2.1)hept-5-ene-2,3-dicarboxylic anhydride, nadic anhydride, methyl nadic anhydride, himic anhydride, methyl himic anhydride, methacrylic acid, methyl acrylate, methyl methacrylate, ethyl acrylate, ethyl methacrylate, propyl acrylate, propyl methacrylate, butyl acrylate, butyl methacrylate, hydroxyethyl acrylate, hydroxyethyl methacrylate, hydroxypropyl methacrylate, acrylonitrile, methyacrylonitrile, acrylamide, methacrylamide, and combinations thereof;
an optional colorant;
at least one surfactant; and
an optional wax,
wherein the weight ratio of the at least one unsaturated polyester resin to the at least one grafting monomer is from about 95:5 to about 50:50, and wherein the acid number of the polyester resin is from about 10 milliequivalents of potassium hydroxide per gram of resin to about 1000 milliequivalents of potassium hydroxide per gram of resin, and
wherein particles comprising the toner have a volume average diameter of from about 3 μm to about 15 μm, and a circularity of from about 0.9 to about 1.

20. The toner according to claim 19, wherein the optional colorant comprises dyes, pigments, combinations of dyes, combinations of pigments, and combinations of dyes and pigments present in an amount of from about 0.1 to about 35 percent by weight of the toner, and the optional wax is selected from the group consisting of polyolefins, carnauba wax, rice wax, candelilla wax, sumacs wax, jojoba oil, beeswax; montan wax, ozokerite, ceresin, paraffin wax, microcrystalline wax, Fischer-Tropsch wax, stearyl stearate, behenyl behenate, butyl stearate, propyl oleate glyceride monostearate glyceride distearate, pentaerythritol tetra behenate, diethyleneglycol monostearate, dipropyleneglycol distearate, diglyceryl distearate, triglyceryl tetrastearate, sorbitan monostearate, cholesteryl stearate, and combinations thereof, present in an amount from about 1 weight percent to about 25 weight percent of the toner.
